(19) United States
(12) Patent Application Publication
(10) Pub. No.: US 2023/0259555 A1
(43) Pub. Date: Aug. 17, 2023

(54) VIDEO RANKING METHOD, AND APPARATUS

(71) Applicant: MOTOROLA SOLUTIONS, INC., CHICAGO, IL (US)

(72) Inventors: TEJEASH DURAIMANICKAM, LUNAS (MY); JOE YIE CHONG, IPOH (MY); CHUN MENG TAN, BAYAN LEPAS (MY)

(21) Appl. No.: 17/650,863

(22) Filed: Feb. 14, 2022

(51) Int. Cl. G06F 16/738; G06F 16/71; G06F 16/783

(52) U.S. Cl. CPC G06F 16/738; G06F 16/71; G06F 16/784

(57) ABSTRACT

A method and apparatus for ranking video for ease of redaction is provided herein. During operation, a video ranking apparatus will determine a plurality of faces and/or objects that need redaction from the plurality of videos and analyze the plurality of videos to determine unique identifiers within the plurality of videos. The video ranking apparatus will then determine a number of unique identifiers for each video and rank the plurality of videos based on the number of unique identifiers for each video.

### BACKGROUND OF THE INVENTION

Redaction is often utilized in video to obfuscate portions of the video in order to protect the identity of individuals. In public-safety scenarios, oftentimes the public requests a video of an incident that needs redaction. Although the process of redaction can be automated, the redaction technician (evidence technician) still needs to manually review the redacted video before releasing the video to the public to make sure no mistakes were made during the redaction process. It is evident that increasing the amount of redaction in a video increases an amount of work for the redaction technician. Therefore, it would be beneficial to choose videos for distribution that need a least amount of redaction.

### BRIEF DESCRIPTION OF THE SEVERAL VIEWS OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention.

FIG. 1 illustrates a video ranking output.

FIG. 2 is a block diagram of an apparatus utilized to rank video.

FIG. 3 illustrates a video ranking output.

FIG. 4 illustrates a video ranking output.

FIG. 5 illustrates a video ranking output.

FIG. 6 is a flow chart showing operation of the apparatus of FIG. 2.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required.

### DETAILED DESCRIPTION

In order to address the above-mentioned need, a method and apparatus for ranking a plurality of videos for ease of redaction is provided herein. During operation, a video ranking apparatus will determine a plurality of faces and/or objects that need redaction from the plurality of videos and analyze the plurality of videos to determine unique identifiers within the plurality of videos. The video ranking apparatus will then determined a number of unique identifiers for each video and rank the plurality of videos based on the number of unique identifiers for each video.

Once the videos are ranked, the videos will be presented to the evidence technician in a ranked order, with the video having a lowest number of unique identifiers given the lowest rank. In an alternate embodiment of the present invention, a total number of affected video frames will also be used to rank the videos so that the ranking of a video will depend on both the number of unique identifiers for each video and a total number of affected video frames within the video (e.g., the rank may comprise a product of the two).

It should be noted that in the above description, a unique identifier comprises any first-seen face or first-seen object within a video that needs to be redacted. For example, in videos where license plates need to be redacted, a particular license-plate that is first seen in the video footage would increment a unique identifier count by 1. If the particular license plate is seen again in the video, the unique identifier count is not incremented. Additionally, an affected video frame comprises any video frame where redaction is needed.

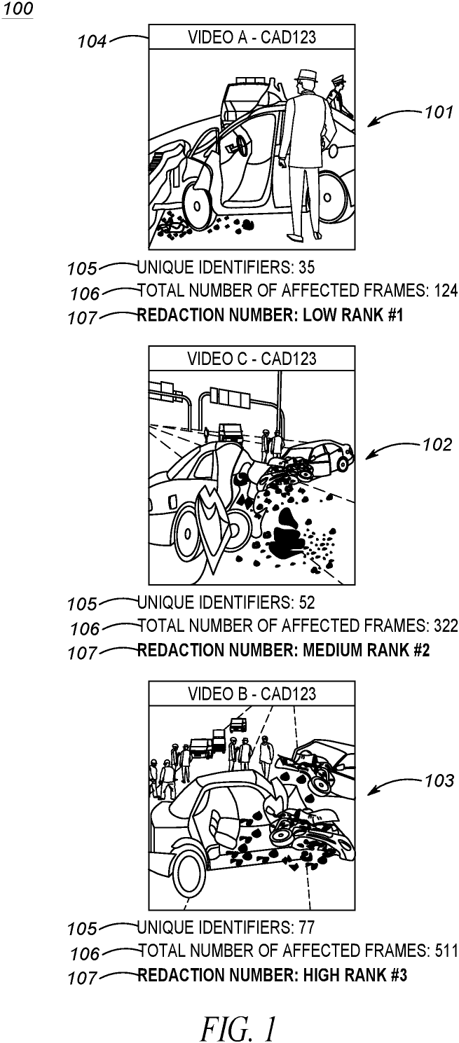

Turning now to the drawings wherein like numerals designate like components, FIG. 1 illustrates video ranking in accordance with one embodiment of the present invention. As shown in FIG. 1, three videos 101-103, identified by thumbnails, are ranked and presented to a user on a graphical-user interface 100. Each video is related to a particular incident, designated by an incident identifier 104 (in this case CAD 123). An incident identifier (sometimes referred to as an incident scene identifier, or a computer-aided dispatch identification (CAD ID)) is generated for incidents where, for example, an officer is dispatched. This ID could be something as simple as a number associated with a particular incident type, or something as complicated as an identification that is a function of populated fields.

As is evident, each video is presented to the redaction technician showing its number of unique identifiers 105 and total number of affected video frames 106. A ranking 107 is also presented to the user that ranks videos 101-103 based on a total number of unique identifiers within each video, with a video having a lowest number of unique identifiers ranked the lowest and a video having a highest number of unique identifiers ranked the highest. As mentioned above, the videos may also be ranked based on both the number of unique identifiers and the total number of affected frames, for example, ranking the videos based on a product of the unique identifiers and the total number of affected frames, with a lowest product having a lowest ranking.

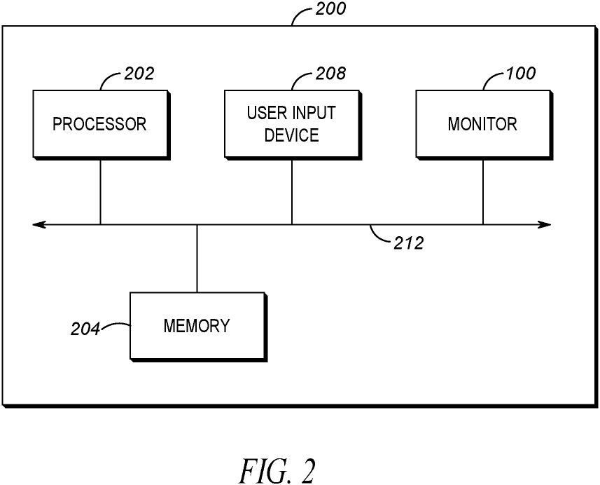

FIG. 2 is a block diagram of apparatus 200 utilized as a video ranking apparatus to rank videos as described above. In various examples, ranking apparatus 200 may be any device capable of executing instructions (sequential or otherwise) that specify actions to be taken by the device. Ranking apparatus 200 may include various components connected by a bus 212. Ranking apparatus 200 may include a hardware processor (logic circuitry) 202 such as one or more central processing units (CPUs) or other processing circuitry able to provide any of the functionality described herein when running instructions. Processor 202 may be connected to a memory 204 that may include a non-transitory machine-readable medium on which is stored one or more sets of instructions. Memory 204 may include one or more of static or dynamic storage, or removable or non-removable storage, for example. A machine-readable medium may include any medium that is capable of storing, encoding, or carrying instructions for execution by processor 202, such as solid-state memories, magnetic media, and optical media. Machine-readable medium may include, for example, Electrically Programmable Read-Only Memory (EPROM), Random Access Memory (RAM), or flash memory. Memory 204 is also configured to store a plurality of videos that may need redaction and an associated incident identifier for each of the plurality of videos. For example, memory 204 comprises many videos acquired by police officers during their routing patrolling, along with other videos acquired by, for example, stationary cameras. At least a portion of the stored videos will have an associated incident identifier that associates the videos with particular incidents.

The instructions may enable ranking apparatus 200 to operate in any manner thus programmed, such as the functionality described specifically herein, when processor 202 executes the instructions. The machine-readable medium may be stored as a single medium or in multiple media, in a centralized or distributed manner. In some embodiments, instructions may further be transmitted or received over a communications network via a network interface (not shown in FIG. 2) utilizing any one of a number of transfer protocols (e.g., frame relay, internet protocol (IP), transmission control protocol (TCP), user datagram protocol (UDP), hypertext transfer protocol (HTTP), etc.).

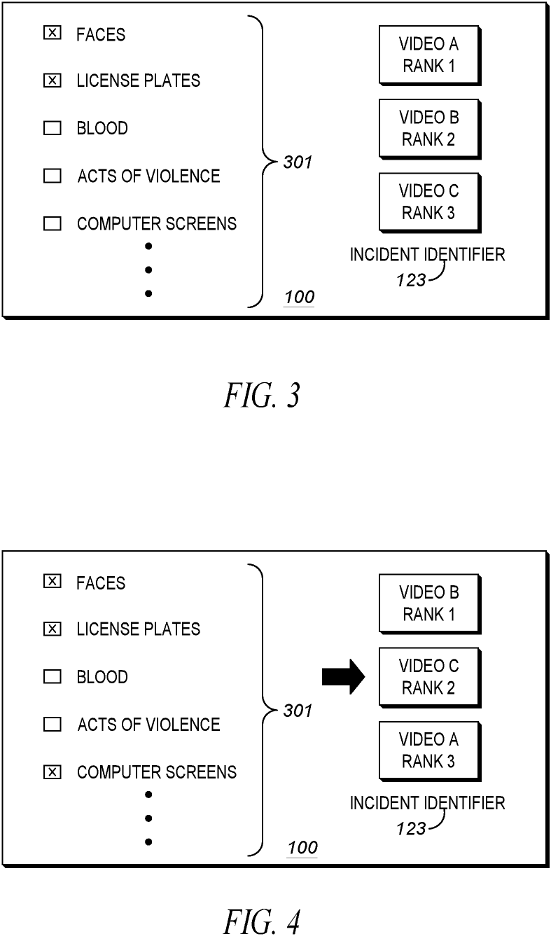

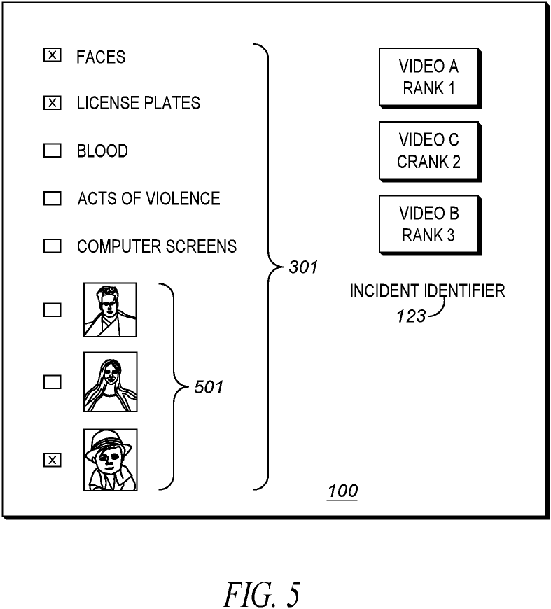

Ranking apparatus 200 may further include one or more monitors 206, to display ranking information as shown in FIG. 1, FIG. 3, FIG. 4, and FIG. 5. Monitor 206 provides a way of conveying (e.g., displaying) information received from processor 202. Part of this information may comprise ranked videos as described above. In order to provide the above features (and additional features), monitor 206 may comprise any combination of a touch screen, a computer screen, or any other interface needed to provide information to the user.

Monitor 206 may be used in conjunction with one or more user input device 208. User input device 208 may include one or more of a keyboard, a microphone, a mouse (or other navigation devices).

During operation, processor 202 receives an incident identifier from user input device 208 and accesses memory 204 to determine all videos related to the received incident identifier. The videos related to the received incident identifier are then ranked by processor 202 as described above, and output to monitor 100. The ranking may then be utilized by a user to determine what videos would require a least amount of work redacting.

In one embodiment of the present invention, processor 202 will analyze all videos associated with the incident identifier to determine things that may need redaction (e.g., faces, license plates, computer screens, ..., etc.) and provide the user with the determined things that may need to be redacted from video (displayed on monitor 100). The user will be allowed to select the things that need to be redacted from the video. This is illustrated in FIG. 3 through FIG. 5.

As shown in FIG. 3 through FIG. 5, a user has input CADID 123 for an incident identifier. Logic circuitry 202 accesses memory 204 and identifies all videos related to incident 123. (Videos may be stored with CAD ID 123 in their file name, or Metadata associated with each video may contain CAD ID 123). Processor 202 then “watches” the videos to determine all items that may need to be redacted. In particular, all unique faces, blood, license plates, ..., etc. are identified and presented to the user as a list of things that may need redacting from all videos related to CAD ID 123.

There are various ways the processor 202 would identify faces and/or objects to be redacted. In one embodiment, the faces and/or objects to be redacted identification could be done based on predefined list subjects of interest from the current CADID. In another embodiment, the faces and/or objects to be redacted identification could be done based on a machine learning from at least one other past public safety case of the same incident type with the current CADID. In another embodiment, the faces and/or objects to be redacted identification could be done based on a NLP parsing from the conversation and report made in the current CADID.

The list of things 301 that potentially could be redacted from video is presented on monitor 100. The user is allowed to select the things that should be redacted from the videos related to CAD ID 123. For example, in FIG. 3, the user has chosen “Faces” and “License Plates” to be redacted from the video. In FIG. 4, the user has additionally selected “Computer Screens” to be redacted.

As is evident the number of unique identifiers and the number of total video frames affected will change based on the user’s selection of what things should be redacted from the video. Thus, as shown in FIG. 3, when a user chooses “Faces” and “License Plates” to be redacted from the videos related to the incident, video A is ranked 1^{st}, video B is ranked 2^{nd}, and Video C is ranked 3^{rd}. However, as shown in FIG. 4, when “Computer Screens” are added to the things that should be redacted from the videos, the result is video B is ranked 1^{st}, video C is ranked 2^{nd}, and Video A is ranked 3^{rd}.

It should be noted that in order to accomplish the above, logic circuitry 202 is configured with a recognition engine/video analysis engine (VAE) that comprises a software engine that analyzes video in order to recognize those things needing redaction. Using the VAE, logic circuitry 202 is capable of “watching” video to detect any item that needs redaction. It should be noted that logic circuitry 202 may be configured to execute those VAEs that detect things 301 presented to the user for potential redaction.

In another embodiment of the present invention, logic circuitry 202 will determine every person whose face is presented in the related videos and present thumbnails of those individuals as potential “things” that can be redacted. This is illustrated in FIG. 5 where faces 501 are presented to the user for potential redaction. More specifically, faces 501 comprise all faces visible in all related videos. The selection of any (or all) of the faces will obviously effect the ranking of the video as described.

In another embodiment of the present invention, logic circuitry 202 will accept user’s input 208 to elect at least a new face and/or object which is not initially being recommended in the list 301 to be added as an additional face and/or object to be redacted. This addition could be done by typing in or uploading a new pictorial document or selecting face and/or object from at least one frame of at least one of the video footages. For example, a user may upload (through input device 208) an image of an individual that needs redaction, and logic circuitry 202 may then include the user in the list of potential things that need redaction.

With the above in mind, FIG. 2 comprises an apparatus comprising memory 204 configured to store videos, monitor 100, and logic circuitry 202. Logic circuitry 202 is configured to determine a subset of stored videos within the memory, determine a plurality of faces and/or objects that need redaction from the subset of stored videos, analyze the subset of stored videos to determine unique identifiers within the subset of stored videos (wherein a unique identifier comprises a first instance within a video of a face or object that needs redaction), determined a number of unique identifiers for each video, rank the subset of stored videos based on the number of unique identifiers for each of the subset of stored videos, and cause monitor 100 to display a ranking for each of the subset of stored videos.

As discussed above, logic circuitry 202 may be further configured to review the subset of stored videos for potential faces and/or objects that may need redaction and present the potential faces and/or objects that may need redaction to a user. Logic circuitry 202 may then determine the plurality of faces and/or objects that need redaction from the subset of stored videos by receiving, from the user via user input device 208, the plurality of faces and/or objects that need redaction from the subset of stored videos.

As discussed above, logic circuitry 202 may be further configured to determine a number of affected frames for each of the subset of stored videos and rank the subset of stored videos based on the number of unique identifiers for each of the subset of stored videos and the number of affected frames for each of the subset of stored videos video.

As discussed above, logic circuitry may be further configured to receive an incident identifier from a user via user input device 208, and determine the subset of stored videos from the incident identifier, wherein the subset of stored videos are all related to an incident identified by the incident identifier.

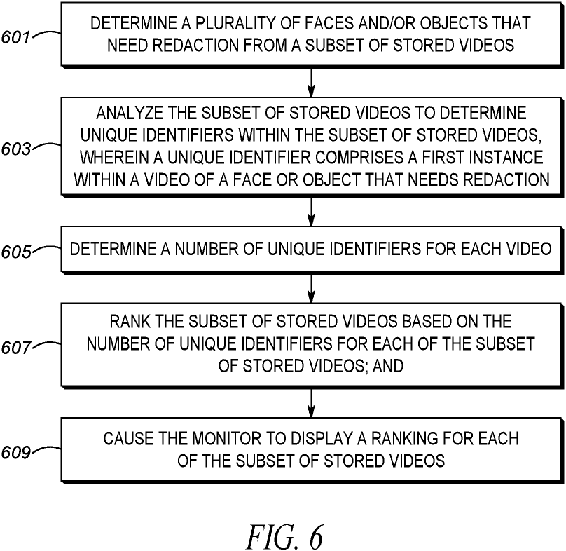

.FIG. 6 is a flow chart showing operation of the system of FIG. 2. The logic flow begins at step 601 where logic circuitry determines a plurality of faces and/or objects that need redaction from a subset of stored videos. At step 603 logic circuitry 202 analyzes the subset of stored videos to determine unique identifiers within the subset of stored videos, wherein a unique identifier comprises a first instance within a video of a face or object that needs redaction. The logic flow continues to step 605 where logic circuitry 202 determines a number of unique identifiers for each video and ranks the subset of stored videos based on the number of unique identifiers for each of the subset of stored videos (step 607). Finally, at step 609, logic circuitry 202 outputs the ranking to monitor 100 causing monitor 100 to display a ranking for each of the subset of stored videos.

In one embodiment of the present invention, logic circuitry 202 also reviews the subset of stored videos for potential faces and/or objects that may need redaction, presents a list of the potential faces and/or objects that may need redaction to a user, and receives from the user, the plurality of faces and/or objects that need redaction from the subset of stored videos. The step of determining the plurality of faces and/or objects that need redaction for the subset of stored videos is based on the step of receiving from the user, the plurality of faces and/or objects that need redaction from the subset of stored videos.

In one embodiment of the present invention, logic circuitry 202 also determines a number of affected frames for each of the subset of stored videos and wherein the step of ranking comprises ranking the subset of stored videos based on the number of unique identifiers for each of the subset of stored videos and the number of affected frames for each of the subset of stored videos video.

In one embodiment of the present invention, user input device 208 receives an incident identifier from a user, provides logic circuitry 202 with the incident identifier, and logic circuitry 202 then determines the subset of stored videos from the incident identifier, wherein the subset of stored videos are all related to an incident identified by the incident identifier.

In the foregoing specification, specific embodiments have been described. However, one of ordinary skill in the art appreciates that various modifications and changes can be made without departing from the scope of the invention as set forth in the claims below. Accordingly, the specification andfigures are to be regarded in an illustrative rather than a restrictive sense, and all such modifications are intended to be included within the scope of present teachings.

Those skilled in the art will further recognize that references to specific implementation embodiments such as “circuitry” may equally be accomplished via either on general purpose computing apparatus (e.g., CPU) or specialized processing apparatus (e.g., DSP) executing software instructions stored in non-transitory computer-readable memory. It will also be understood that the terms and expressions used herein have the ordinary technical meaning as is accorded to such terms and expressions by persons skilled in the technical field as set forth above except where different specific meanings have otherwise been set forth herein.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises ... a”, “has ... a”, “includes ... a”, “contains ... a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. An apparatus comprising:
a memory comprising a non-transitory machine-readable medium on which is stored one or more sets of computer code and [configured to store] videos;
a monitor;
[ logic circuitry configured to:]
a processor, executing the computer code that causes the processor to:
determine a subset of stored videos within the memory;
determine a plurality of faces and/or objects that need redaction from the subset of stored videos;
analyze the subset of stored videos to determine unique identifiers within the subset of stored videos, wherein a unique identifier comprises a first instance within a video of a face or object that needs redaction;
determine a number of unique identifiers for each video;
rank the subset of stored videos based on the number of unique identifiers for each of the subset of stored videos; and
a monitor comprising a touch screen or computer screen configured to display the rank or ranking for each of the subset of stored videos.

2. The apparatus of claim 1 wherein the logic circuitry is further configured to:
review the subset of stored videos for potential faces and/or objects that may need redaction;
present the potential faces and/or objects that may need redaction to a user; and
determine the plurality of faces and/or objects that need redaction from the subset of stored videos by receiving, from the user, the plurality of faces and/or objects that need redaction from the subset of stored videos.

3. The apparatus of claim 1 wherein the [logic circuitry] the computer code further causes the processor [is further configured] to:
determine a number of affected frames for each of the subset of stored videos; and
rank the subset of stored videos based on the number of unique identifiers for each of the subset of stored videos and the number of affected frames for each of the subset of stored videos.

4. The apparatus of claim 1 wherein the [logic circuitry] processor is further configured to:
receive an incident identifier from a user; and
determine the subset of stored videos from the incident identifier, wherein the subset of stored videos are all related to an incident identified by the incident identifier.

5. An apparatus comprising:
a memory comprising a non-transitory machine-readable medium on which is stored one or more sets of computer code and [configured to store] videos;
a user input;
[ logic circuitry configured to:]
a processor, executing the computer code that causes the processor to:
receive an incident identifier from a user via the user input;
determine a subset of stored videos from the stored videos within the memory from the incident identifier, wherein the subset of stored videos are all related to an incident identified by the incident identifier;
review the subset of stored videos for potential faces and/or objects that may need redaction;
present a list of the potential faces and/or objects that may need redaction to a user;
determine a plurality of faces and/or objects that need redaction from the subset of stored videos by receiving, from the user, the plurality of faces and/or objects that need redaction from the subset of stored videos;
analyze the subset of stored videos to determine unique identifiers within the subset of stored videos, wherein a unique identifier comprises a first instance within a video of a face or object that needs redaction;
determine a number of unique identifiers for each video;
rank the subset of stored videos based on the number of unique identifiers for each of the subset of stored videos; and
a monitor comprising a touch screen or a computer screen, configured to display the rank or ranking for each of the subset of stored videos.

6. The apparatus of claim 5 wherein the computer code further causes the processor [logic circuitry is further configured ]to:
determine a number of affected frames for each of the subset of stored videos; and
rank the subset of stored videos based on the number of unique identifiers for each of the subset of stored videos and the number of affected frames for each of the subset of stored videos.

7. (canceled)

8. (canceled)

9. (canceled)

10. (canceled)
